(19) United States
(12) Patent Application Publication
(10) Pub. No.: US 2012/0005041 A1
(43) Pub. Date: Jan. 5, 2012

(54) MOBILE CONTENT DISTRIBUTION WITH DIGITAL RIGHTS MANAGEMENT

(75) Inventors: Japan A. Mehta, Coppell, TX (US); Shafiq Kassam, Lewisville, TX (US); Enrique Ruiz-Velasco, Flower Mound, TX (US); Shahzaib Zafar, Coppell, TX (US)

(73) Assignee: VERIZON PATENT AND LICENSING, INC., Basking Ridge, NJ (US)

(21) Appl. No.: 12/826,925

(22) Filed: Jun. 30, 2010

(51) Int. Cl. G06F 15/16; G06Q 30/00

(52) U.S. Cl. 705/27.1; 709/203; 705/26.1

(57) ABSTRACT

A server distributes, to a mobile device, a catalog of available digital content and receives, from the mobile device, a request to download multiple digital content files based on the catalog. The server sends, to the mobile device, the multiple digital content files, where the each of the multiple digital content files includes access restrictions to prevent unauthorized rendering. The server receives, from the mobile device, a request to render one of the multiple digital content files on the mobile device and determines whether rendering of the one of the multiple digital content files on the mobile device is authorized. The server sends, to the mobile device, information to enable rendering of the one of the multiple digital content files if the mobile device is authorized and applies charges, to a user account associated with the mobile device, based on the sending the information to enable the rendering.

### BACKGROUND INFORMATION

Mobile electronic devices (such as laptop computers, personal digital assistants (PDAs), smartphones, multimedia players, gaming systems, etc.) provide the ability for consumers to use content “on the go.” Examples of content may include digital books, videos, images, games, and music. Many of these mobile electronic devices provide mechanisms (such as wired or wireless network access) to download content in a variety of geographic locations. However, not all locations offer sufficient (or any) bandwidth to allow a consumer to download or stream multimedia content. Thus, a consumer may identify preferred wireless access locations, such as a home, an office, or another known “hot spot” that may provide sufficient bandwidth to transfer content in advance of departing for another location. In other instances, a consumer may use a physical (wired) network connection to transfer selected content to a mobile electronic device prior to “going mobile.” Such practices require a certain amount of foresight by the consumer to accurately predict a need for desired content.

A digital rights management (DRM) system protects content by separating the content from the rights associated with the content. The content provider (e.g., video distributors, book publishers, music labels, etc.) encrypts the content and creates a Rights Object (RO) for the encrypted content. The RO may include policies associated with the content. For example, the RO may include (1) details about rights granted to the content user regarding use or “rendering” of the content and (2) a decryption key to decrypt the content. When the user renders the content on, for example, a mobile electronic device, a “DRM agent” in the device ensures that the user can render the content only according to the policies specified in the RO. Thus, the DRM agent prevents unauthorized rendering. “Rendering” may include performing any function on DRM content, including playing, viewing, or copying.

### BRIEF DESCRIPTION OF THE DRAWINGS

FIG. 1 depicts an exemplary network in which systems and/or methods described herein may be implemented;

FIG. 2 is a block diagram of exemplary components of a device that may correspond to a backend server, a mobile device, and/or a local computer of FIG. 1;

FIG. 3 is a diagram of exemplary functional components of the backend server of FIG. 1;

FIG. 4 is a diagram of exemplary functional components of the mobile device of FIG. 1;

FIGS. 5 and 6 provide a process flow illustrating exemplary server operations to conduct mobile media content distribution with digital rights management (DRM);

FIG. 7 provides exemplary communications for a mobile media content distribution operation capable of being performed by the devices of FIGS. 1-4; and

FIGS. 8 and 9 provide exemplary screens that may be displayed on the mobile device of FIG. 1 during mobile media content distribution operations.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Implementations described herein may enable users of mobile devices to pre-select content and download the content prior to committing to a purchase of the content. The pre-selected content may be downloaded to a mobile device—prior to a consumer being charged—using, for example, a high bandwidth network connection. The pre-selected content may include copyright protections, such as digital rights management (DRM) license keys, that limit use of the pre-selected content on the mobile device. A consumer may store the pre-selected content in memory of the mobile device and decide to view the pre-selected content at a later time (e.g., a time when a high bandwidth connection is not available). In one implementation, the mobile device may initiate a low-bandwidth transaction with a backend server to obtain authorization and initiate appropriate payment when a user elects to render the pre-selected content. In another implementation, the mobile device may track a rendering instance (e.g., viewing, listening, playing, etc.) of the pre-selected content and may synchronize with a backend server, to initiate appropriate payment, when a network connection becomes available.

As used herein, the terms “user,” “subscriber,” “consumer,” and “customer” may be used interchangeably. Also the terms “user,” “subscriber,” “consumer,” and “customer” may be broadly interpreted to include a mobile device or a user of a mobile device.

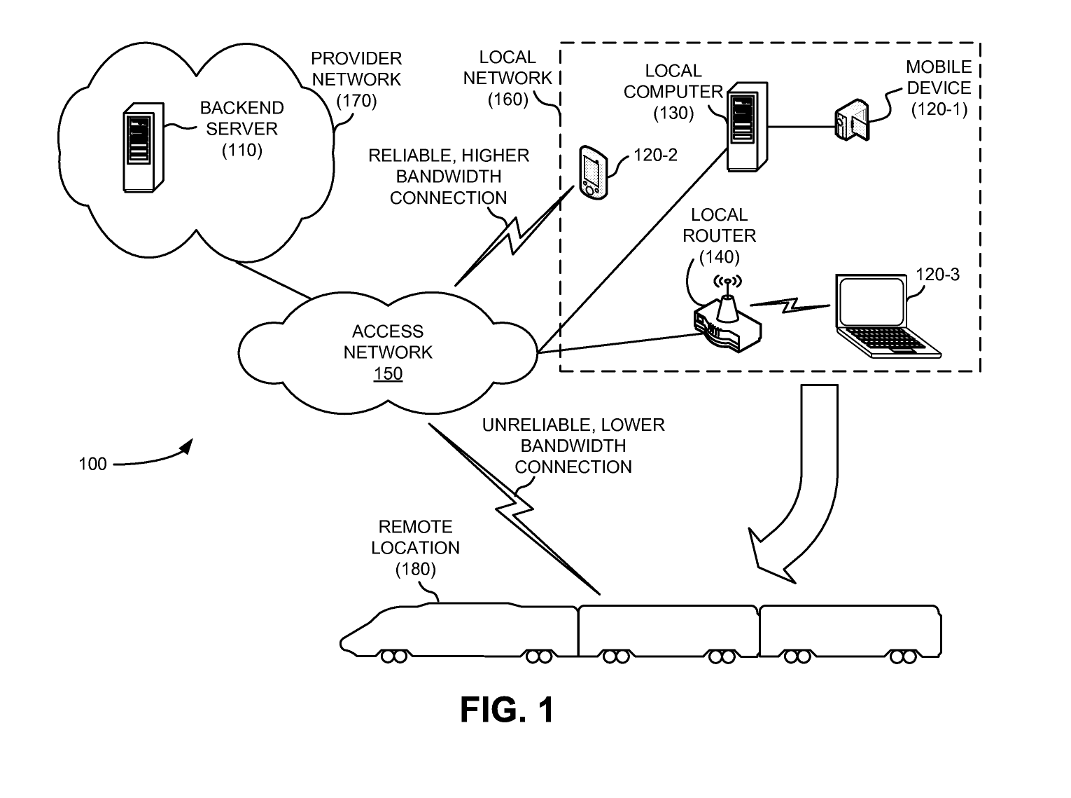

FIG. 1 is a diagram of an exemplary environment 100 in which systems and/or methods described herein may be implemented. As illustrated, environment 100 may include a backend server 110, mobile devices 120-1, 120-2, and 120-3, (herein referred to collectively as “mobile devices 120” and generically as “mobile device 120”), a local computer 130, a local router 140, and an access network 150. Mobile devices 120, local computer 130, and local router 140 may be included within a local network 160, such as a customer's premises. Backend server 110 may be included within a provider network 170. Components of network 100 may interconnect via wired and/or wireless connections.

For simplicity, one access network 150, one local network 160, and one provider network 170 have been illustrated in FIG. 1. In practice, there may be more access networks, local networks, and provider networks. Also, each of access network 150, local network 160, and provider network 170 may contain additional, fewer, different, or differently arranged devices than shown in FIG. 1. For example, backend server 110 may include a virtual server that includes a group of servers that may logically appear as one server. Also, backend server 110 may connect to one or more databases and other servers (not shown) to store and/or retrieve customer data and/or content. Furthermore, in some instances, one or more of the components of environment 100 may perform one or more functions described as being performed by another one or more of the components of environment 100.

Backend server 110 may include one or more server devices, or other types of computation or communication devices, that are capable of providing content/information to mobile device 120/local computer 130 in accordance with signals that are issued from mobile device 120/local computer 130. For example, backend server 110 may provide a list of content available for pre-selection and downloading by mobile devices 120. Backend server 110 may communicate with a variety of other components, such as third-party servers, databases, gateways, web servers, network switches or routers, television broadcast facilities, and other servers to facilitate delivery of pre-selected content to mobile devices 120 via access network 150. In one implementation, backend server 110 may be a part of an account-based network service provided by a subscription multimedia service provider.

Backend server 110 may also separately provide DRM information for transfer of content from backend server 110 to mobile device 120 in a secure manner. Using DRM information, backend server 110 may implement control over, for example, a number of copies (e.g., of content) that may be made, who can access certain content, etc. Backend server 110 may restrict access based on DRM properties/protections assigned by an entity that creates a content file. In one implementation, backend server 110 may provide a DRM rights object (RO) (or another form of authorization) that is separate from the pre-selected content to enable access (by mobile device 120) to the pre-selected content. The RO may be provided in response to a request or notification from mobile device 120 to render the pre-selected content.

In another implementation, backend server 110 may perform synchronization operations by communicating with mobile device 120 to determine which pre-selected content, stored on mobile device 120, has previously been rendered and/or which files have not yet been rendered. Backend server 110 may, based on the synchronization operation, update account/billing information associated with mobile device 120 to reflect rendering of the pre-selected content. If, during the synchronization operation, backend server 110 determines that mobile device 120 has stored content files that have expired access rights, then backend server 110 may instruct mobile device 120 to delete the expired content files.

Mobile device 120 may include a computation or communication device, such as a wireless mobile communication device that is capable of communicating with backend server 110, local computer 130, and/or local router 140. Mobile device 120 may also include capabilities to store and render pre-selected content. For example, mobile device 120 may include a radiotelephone, a personal communications system (PCS) terminal (e.g., that may combine a cellular radiotelephone with data processing and data communications capabilities), a PDA (e.g., that can include a radiotelephone, a pager, Internet/intranet access, etc.), a laptop computer, a camera, a personal gaming system, or another type of computation or communication device that may be capable of presenting/exchanging multimedia content. In one implementation, mobile device 120 may generate and/or store information in a memory associated with mobile device 120. Additionally, or alternatively, mobile device 120 may send an account registration request to backend server 110. The request may include information associated with mobile device 120 (e.g., a device identifier, an email address, a username, a password, PIN, etc.). In an implementation, mobile device 120 may store and present content received from backend server 110.

In one implementation, mobile device 120 may also track use of pre-selected content and perform synchronization operations by communicating with backend server 110 to determine which pre-selected content, stored on mobile device 120, has previously been used. In another implementation, mobile device 120 may delete unused content after a particular period of time (e.g., 30 days). In another implementation, mobile device 120 may communicate with backend server 110 to obtain access to pre-selected content that is stored on mobile device 120. Based on selection of particular content by a user, mobile device 120 may send a request to backend server 110 to request access (e.g., a RO) to the particular pre-selected content file. Mobile device 120 may provide credentials to backend server 110. Assuming the credentials are deemed valid, backend server 110 may provide a license key to decrypt the pre-selected content. The description to follow generally refers to mobile device 120 as a wireless mobile communication device. The description is not limited, however, to a wireless mobile communication device and may equally apply to other types of portable devices.

Local computer 130 may include any device capable of receiving, transmitting and/or processing information to and/or from access network 150. Local computer 130 may be capable of receiving input from a user via peripheral devices, such as mobile devices 120. Local computer 130 may also be capable of sending data to and/or receiving data from backend server 110 and/or local router 140. Local computer 130 may further retrieve and/or store credentials that may be used to obtain access to content governed by DRM restrictions. Local computer 130 may also be used by users to access accounts with Internet service providers (ISPs) to send/receive content over access network 150. Thus, in one implementation, local computer 130 may server as an interface between backend server 110 and mobile device 120.

Local router 140 may include a device that may provide connectivity between equipment within local network 160 (e.g., mobile devices 120, local computer 130, etc.) and between the local network 160 equipment and access network 150. In one implementation, local router 140 may include a wireless router that permits mobile devices 120 to connect to other customer premises equipment (e.g., local computer 130, another mobile device 120, etc.). Local router 140 may employ one or more short-range wireless communication protocols for a wireless personal area network (WPAN) and/or a wireless local area network (WLAN), such as, for example, IEEE 802.15 (e.g., Bluetooth) and IEEE 802.11 (e.g., Wi-Fi). In other implementations, different short-range wireless protocols and/or frequencies may be used. In one implementation, some or all of the features of local router 140 may be included within another device, such as local computer 130.

Access network 150 may include a network and system that permit transfer of data between backend server 110 and mobile devices 120/local computer 130. Access network 150 may include, for example, a single network, such as a wide area network (WAN), a local area network (LAN), a metropolitan area network (MAN), a telephone network (e.g., a public switched telephone network (PSTN) or a wireless network), the Internet, a satellite network, etc., or a combination of networks. Access network 150 may provide mobile devices 120 with content provided by backend server 110.

Local network 160 may include a private network, such as a LAN, an ad hoc network, and/or an intranet. Local network 160 may include a wired LAN and/or a wireless LAN (e.g., a Wi-Fi network). Generally, local network 160 may provide mobile devices 120 with a relatively high bandwidth connection to access network 150/provider network 170. More particularly, local network 160 may provide high-bandwidth (e.g., five megabytes per second more) that permits reliable downloads of pre-selected content.

Provider network 170 may represent a network associated with a particular multimedia service provider. For example, provider network 170 may include a LAN or a combination of networks to collect, catalog, store, and/or distribute content and related DRM mechanisms.

In an exemplary implementation using environment 100, backend server 110 may provide a catalog/list of available multimedia content to mobile device 120. Backend server 110 (or another device associated with provider network 170 in communication with backend server 110) may prepare the available multimedia content with DRM properties/protections. A user of mobile device 120 may pre-select, from the catalog, content that may be downloaded to mobile device 120 while using, for example, high bandwidth network capabilities of local network 160. The pre-selected content may be downloaded to mobile device 120 without requiring payment in advance.

A user may bring mobile device 120 to a remote location 180 (e.g., a train (as shown), another moving vehicle, or a remote stationary location), and the user may choose particular pre-selected content to render. In an example implementation, remote location 180 may have unreliable, limited, or no connection to access network 150. In one implementation (e.g., where mobile device 120 has limited/intermittent network access), mobile device 120 may use a low bandwidth connection to communicate with backend server 110 to enable the rendering of particular pre-selected content and to transact related charges. In another implementation (e.g., where mobile device 120 has no network access), mobile device 120 may log use of the pre-selected content and conduct a billing transaction the next time mobile device 120 is connected to backend server 110. If mobile device 120 fails to reconnect to backend server 110 within a particular period of time after a pre-select content download, backend server 110 may charge (or bill) a user's account for all the pre-selected content. Thus, a user may pre-select multiple content files that may be downloaded for future use, but only content that is actually used may require payment.

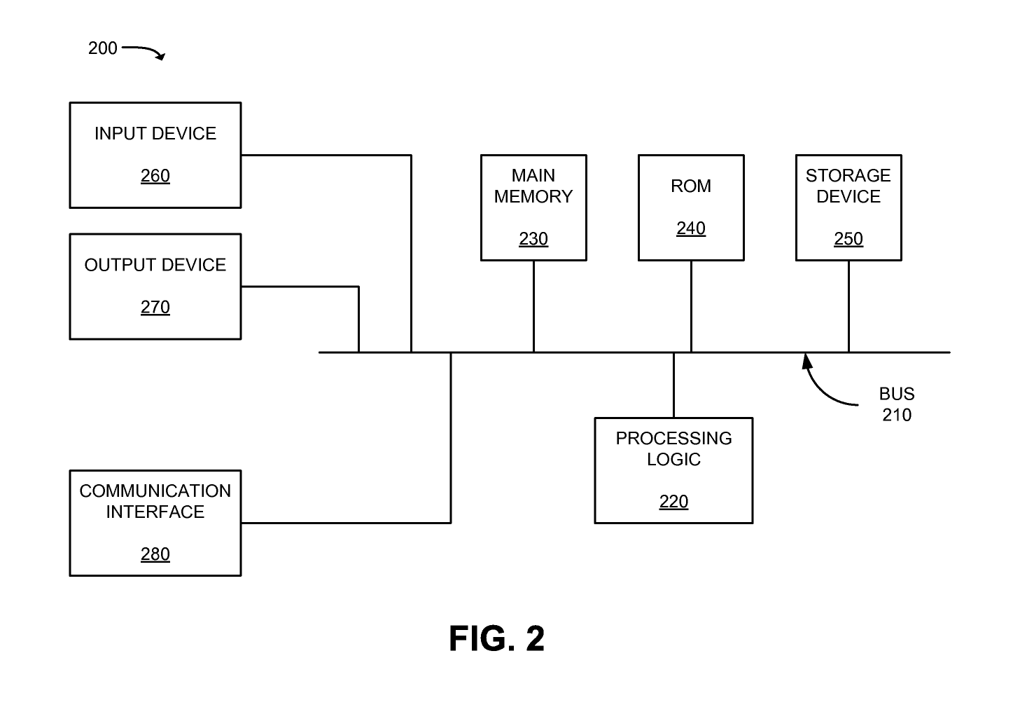

FIG. 2 is diagram illustrating exemplary components of a device 200 that may correspond to any of backend server 110, mobile device 120 (in some implementations), and/or local computer 130. As illustrated, device 200 may include a bus 210, processing logic 220, a main memory 230, a read-only memory (ROM) 240, a storage device 250, an input device 260, an output device 270, and a communication interface 280.

Bus 210 may include a path that permits communication among the components of device 200. Processing logic 220 may include a processor, microprocessor, or other type of processing logic, such as an application-specific integrated circuit (ASIC), a field-programmable gate array (FPGA), etc., that may interpret and execute instructions.

Main memory 230 may include a RAM or another type of dynamic storage device that stores information and instructions for execution by processing logic 220. ROM 240 may include a ROM device or another type of static storage device that may store static information and instructions for use by processing logic 220. Storage device 250 may include a magnetic and/or optical recording medium and its corresponding drive. In one implementation, storage device 250 may also include a database.

Input device 260 may include a mechanism that permits an operator to input information to device 200, such as a keyboard, a mouse, a pen, voice recognition and/or biometric mechanisms, a touch-screen interface, etc. Output device 270 may include a mechanism that outputs information to the operator, including a display, a printer, a speaker, etc. Communication interface 280 may include any transceiver-like mechanism that enables device 200 to communicate with other devices and/or systems.

As will be described in detail below, device 200 may perform certain operations associated with providing mobile media content distribution with DRM. Device 200 may perform these and other operations in response to processing logic 220 executing software instructions contained in a computer-readable medium, such as main memory 230. A computer-readable medium may be defined as a physical or logical memory device. A logical memory device may refer to memory space within a single, physical memory device or spread across multiple, physical memory devices. The software instructions may be read into main memory 230 from another computer-readable medium, such as storage device 250, or from another device via communication interface 280. The software instructions contained in main memory 230 may cause processing logic 220 to perform processes that will be described later. Alternatively, hardwired circuitry may be used in place of, or in combination with, software instructions to implement processes consistent with exemplary implementations. Thus, implementations described herein are not limited to any specific combination of hardware circuitry and software.

Although FIG. 2 illustrates exemplary components of device 200, in other implementations, device 200 may include fewer components, additional components, different components, and/or differently arranged components than those depicted in FIG. 2. Alternatively, or additionally, one or more components of device 200 may perform one or more other tasks described as being performed by one or more other components of device 200.

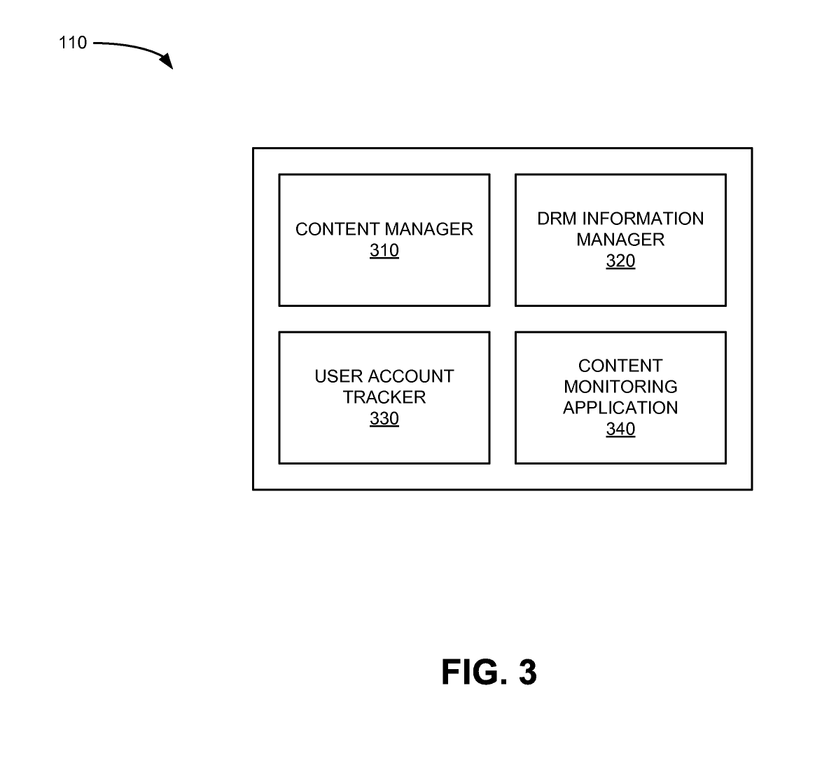

FIG. 3 provides a diagram of exemplary functional components of backend server 110. As shown, backend server 110 may include a content manager 310, a DRM information manager 320, a user account tracker 330, and a content monitoring application 340. The functions described in FIG. 3 may be performed by one or more of the exemplary components of device 200 depicted in FIG. 2.

Content manager 310 may include hardware or a combination of hardware and software to receive, store, and track available multimedia content. Content manager 310 may publish and update a directory of available content that may be accessed by mobile devices 120 to enable a user to pre-select content. The directory may include content references of available content and/or links to shared content that may be retrieved by mobile devices 120. In some implementations, content manager 310 may include a single directory or individual topical directories with a list of available content that may be accessed by mobile devices 120. Content manager 310 may receive a request for particular pre-selected content from a mobile device 120. Content manager 310 may request approval from other functional components (e.g., user account tracker 310, DRM information manager 320) and may supply approved content to requesting mobile devices 120.

DRM information manager 320 may include hardware or a combination of hardware and software to manage DRM security information used to control access to digital content, such as an RO database, a rights issuer database, and/or a domain database. For example, DRM information manager 320 may authenticate a mobile device 120 and provide DRM security information, separate from the pre-selected content, to permit rendering of pre-selected content on mobile device 120. As used herein, “DRM security information” may refer to digital information that governs the use (or “rendering”) of multimedia content. For example, in one implementation, “DRM security information” may include an RO database. Pre-selected content may be encrypted using a secret key, which makes the information only usable on mobile devices 120 having the secret key. The RO database may include the policies associated with content available for pre-selection. The RO database may include “stateful rights” for which backend server 110 may explicitly maintain state information to correctly enforce permissions for rendering. Examples of state information may include the date/time of rendering or rendering count. A policy using a date/time of rendering may be, for example, that pre-selected content must be rendered within a particular number (e.g., 5, 30, 90, etc.) of days. A policy using a rendering count may be, for example, that a user cannot view a video more than once. In this example, a local client monitoring application (e.g., DRM agent 440) residing on mobile device 120 may keep a count of the number of renderings of the content and restrict access beyond the rendering count limit.

The rights issuer database of DRM information manager 320 may include a private key and certificate associated with a publisher of particular content. Backend server 110 may provide the appropriate private key from the rights issuer database to a mobile device 120, and mobile device 120 may decrypt DRM-enabled content with the private key. In one implementation, backend server 110 may ensure the “integrity” of the DRM-enabled content (e.g., making sure the DRM content has not changed) using the appropriate certificate from the rights issuer database. The domain database may include information indicating what types of devices, such as mobile device 120, may be allowed to render DRM-enabled content.

User account tracker 330 may include hardware or a combination of hardware and software to store and update account information associated with mobile devices 120. User account tracker 330 may solicit and receive information from user devices 120 to establish a user account. User accounts may include contact information (e.g., an email address, a physical address, a phone number, etc.), payment information (e.g., a credit card number, e-commerce accounts, etc.), and user activity logs. For example, user account tracker 330 may store a history of pre-selected/downloaded content associated with a particular mobile device 120.

User account tracker 330 may also include subscription information associated with each mobile device 120. Subscription information may include, for example, a level of subscription service (e.g., pay-as-you-go, incremental packages, promotions, etc.) associated with the user account, order histories, user preferences (e.g., content formats, payment methods, etc.), personal information (e.g., other contact information, etc.), and the like. User account tracker 330 may also track usage rates and/or statistics for user accounts.

In one implementation, user account tracker 330 may calculate charges for a user account, based on tracked usage and pricing information associated with particular pre-selected content. For example, user account tracker 330 may receive (e.g., from content monitoring application 340) notification that particular pre-selected content has been rendered or remains unaccounted for after a designated expiration period.

Content monitoring application 340 may include hardware or a combination of hardware and software to allow backend server 110 to supervise DRM-based transfers to mobile device 120. Content monitoring application 340 may receive a notification from mobile device 120 indicating that particular pre-selected content either has been rendered. Additionally, or alternatively, content monitoring application 340 may receive a request from mobile device 120 to render particular pre-selected content. Content monitoring application 340 may signal DRM information manager 320 to provide required DRM security information and may signal user account tracker 330 to update the user account status. In one implementation, content monitoring application 340 may provide (e.g., as part of an account generation process) a client monitoring program that may reside on mobile device 120. In one implementation, content monitoring application 340 may receive credentials from a mobile device 120 associated with a user to determine if the user is authorized to receive requested digital content (e.g., pre-selected content). In another implementation, content monitoring application 340 may receive a unique identifier associated with mobile device 120 and use the unique identifier to obtain account information for the user. In one implementation, content monitoring application 340 may monitor the age of pre-selected content for individual user accounts to ensure that unused (e.g., not rendered) pre-selected content is deleted from mobile device 120 after a designated period. In an implementation, if pre-selected content remains unaccounted for beyond a designated period, content monitoring application 340 may notify user account tracker 330 to charge the user's account.

Although FIG. 3 illustrates exemplary functional components of backend server 110, in other implementations, backend server 110 may include fewer functional components, additional functional components, different functional components, and/or differently arranged functional components than those depicted in FIG. 3. Alternatively, or additionally, one or more functional components of backend server 110 may perform one or more other tasks described as being performed by one or more other functional components of backend server 110.

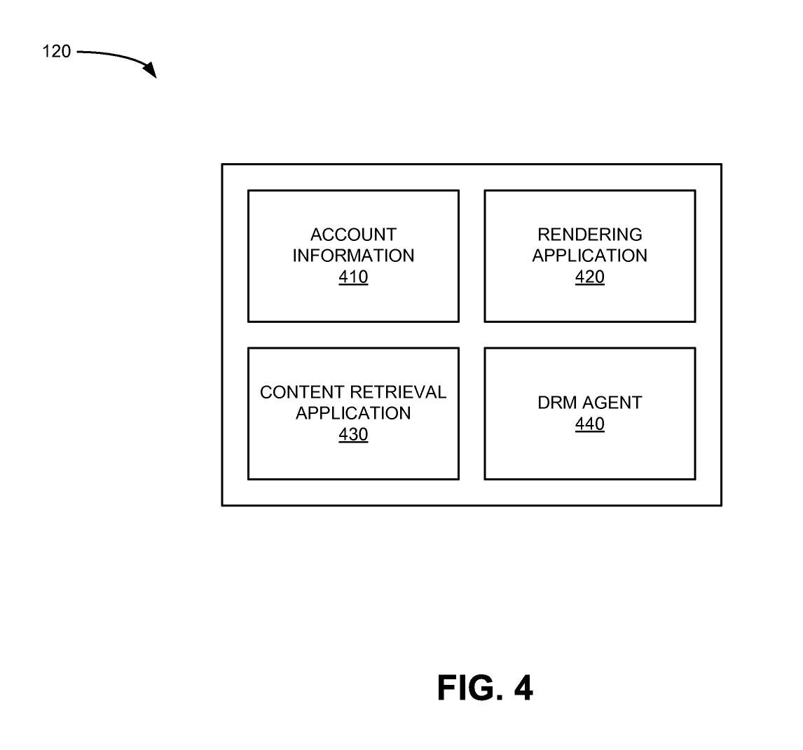

FIG. 4 provides a diagram of exemplary functional components of mobile device 120. As shown, mobile device 120 may include account information 410, a rendering application 420, a content retrieval application 430, and a DRM agent 440. The functions described in FIG. 4 may be performed by one or more of the exemplary components of device 200 depicted in FIG. 2.

Account information 410 may include, for example, information for user accounts associated with a mobile device 120. In one implementation account information 410 may include a unique identification number and/or character string for mobile device 120. The unique identification number and/or character string may be provided to backend server 110 to pull related account information. In other implementations, account information may include particular account information, such as listings of pre-selected/downloaded content, subscription information, order histories, user preferences, personal information, and the like.

Rendering application 420 may include hardware or a combination of hardware and software for rendering pre-selected content on mobile device 120. For example, rendering application 420 may provide a browser, as well as interfaces between the browser and the components in FIG. 2 (e.g., communication interface 280). In yet another example, rendering application 420 may provide a Transmission Control Protocol (TCP)/Internet Protocol (IP) stack to support communication applications, such as content retrieval application 430.

Content retrieval application 430 may include hardware or a combination of hardware and software for requesting and receiving a catalog of available content from backend server 110 and/or obtaining pre-selected content files from backend server 110. Content retrieval application 430 may also include decryption capabilities to decrypt encrypted content provided, for example, from backend server 110. In one implementation, content retrieval application 430 may monitor the age of pre-selected content for individual user accounts to delete unused (e.g., not rendered) pre-selected content after a designated period.

DRM agent 440 may hardware or a combination of hardware and software for accessing security information from backend server 110 to provide DRM-related information or retrieving DRM-related information over access network 150. For example, DRM agent 440 may access the RO database, the rights issuer database, and/or the domain database from DRM information manager 320. DRM agent 440 may use content retrieval application 430 to help coordinate the transfer of DRM security information and pre-selected content from backend server 110 to mobile device 120.

Although FIG. 4 illustrates exemplary functional components of mobile device 120, in other implementations, mobile device 120 may include fewer functional components, additional functional components, different functional components, and/or differently arranged functional components than those depicted in FIG. 4. Alternatively, or additionally, one or more functional components of mobile device 120 may perform one or more other tasks described as being performed by one or more other functional components of mobile device 120.

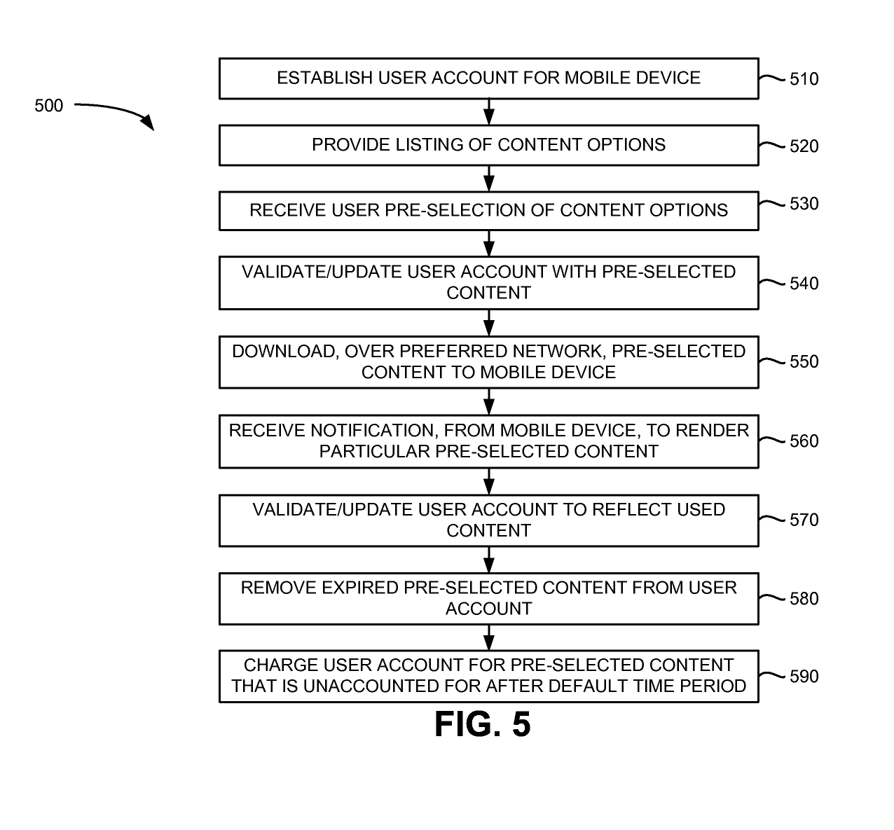

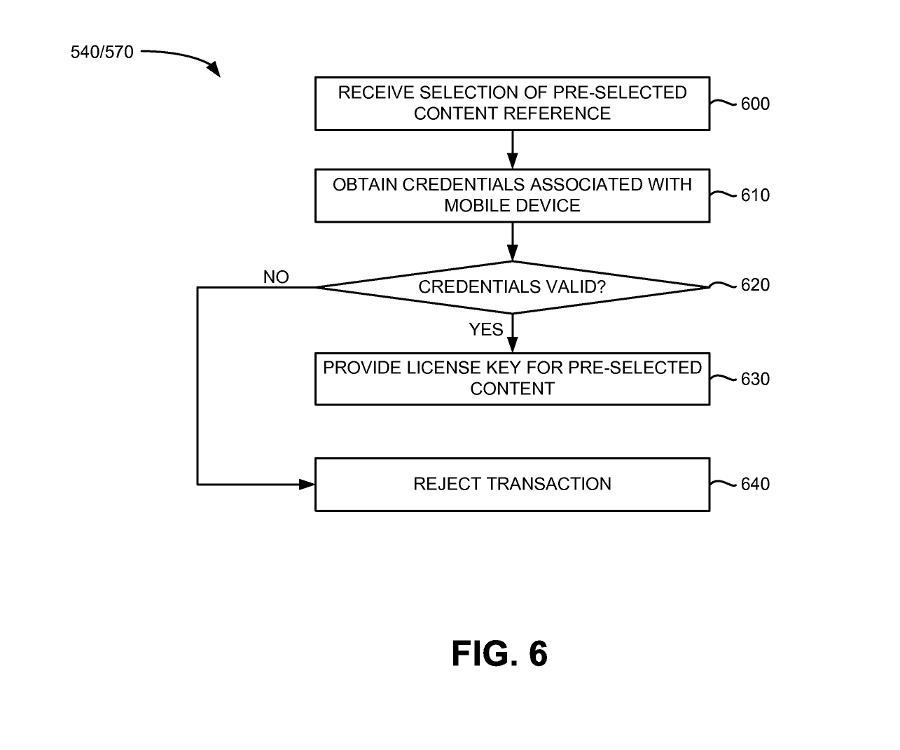

FIGS. 5 and 6 provide a process flow 500 illustrating exemplary server operations to conduct mobile media content distribution with DRM. The operations may be performed by one or more servers associated with a multimedia service provider, such as backend server 110. In some implementations, certain operations may be performed by one or more mobile devices 120 in conjunction with backend server 110.

Process 500 may include establishing a user account for a mobile device (block 510). For example, backend server 110 may communicate with mobile device 120 to establish a user account for mobile content distribution. As described in connection with FIG. 3, in one implementation, user account tracker 330 may solicit and receive information from user devices 120 to establish a user account. User accounts may include contact information (e.g., an email address, a physical address, a phone number, etc.), payment information (e.g., a credit card number, e-commerce accounts, etc.), and user activity logs.

A listing of content options may be provided (block 520) and a user's pre-selection of content options may be received (block 530). For example, backend server 110 may provide a listing of available content to mobile device 120 that enables a user of mobile device 120 to pre-select some of the available content. In one implementation, as described above in connection with FIG. 3, content manager 310 may publish and update a directory of available content that may be accessed by mobile devices 120 to enable a user to pre-select content. The directory may include content references of available content and/or links to shared content that may be retrieved by mobile devices 120. In some implementations, content manager 310 may include a single directory or individual topical directories with a list of available content that may be accessed by mobile devices 120. Content manager 310 may receive a request for particular pre-selected content from a mobile device 120.

The user account may be validated and/or updated to reflect the pre-selected content (block 540), and the pre-selected content may be downloaded, over a preferred network, to the mobile device (block 550). For example, backend server 110 may establish that the requesting user account is authorized to receive pre-selected content and update the user account status to reflect the requested pre-selected content. The pre-selected content may be downloaded to mobile device 120 using, for example, a reliable, high bandwidth connection from a known location (e.g., local network 160 of FIG. 1). In one implementation, as described above in connection with FIG. 3, content manager 310 may request approval of pre-selected content from other functional components (e.g., user account tracker 310, DRM information manager 320, etc.) and may supply approved content to requesting mobile devices 120. DRM information manager 320 may authenticate a mobile device 120 and provide DRM security information, separate from the pre-selected content, to permit rendering of pre-selected content on mobile device 120.

A notification of rendering of particular pre-selected content may be received (block 560), and the user account may be updated and/or validated to reflect the used content (block 570). For example, backend server 110 may receive a notification that pre-selected content (e.g., content previously downloaded and stored on mobile device 120) has been rendered. As another example, backend server 110 may receive a request from mobile device 120 to obtain rights (e.g., DRM security information) to render pre-selected content. In one implementation, as described above in connection with FIG. 3, content monitoring application 340 may receive a notification from mobile device 120 indicating that particular pre-selected content either has been rendered. Additionally, or alternatively, content monitoring application 340 may receive a request from mobile device 120 to render particular pre-selected content. Content monitoring application 340 may signal DRM information manager 320 to provide required DRM security information and may signal user account tracker 330 to update the user account status.

Expired pre-selected content may be removed from the user account (block 580), and the user account may be charged for content that is unaccounted for after a default time period (block 590). For example, backend server 110 may monitor the status of pre-selected content that is stored on mobile device 120. In one implementation, as described above in connection with FIG. 3, content monitoring application 340 may monitor the age of pre-selected content for individual user accounts to ensure that unused (e.g., not rendered) pre-selected content is deleted from mobile device 120 after a designated period. In an implementation, if pre-selected content remains unaccounted for beyond a designated period, content monitoring application 340 may notify user account tracker 330 to charge the user's account. User account tracker 330 may calculate charges for a user account, based on tracked usage and pricing information associated with particular pre-selected content. For example, user account tracker 330 may receive (e.g., from content monitoring application 340) notification that particular pre-selected content has been rendered or remains unaccounted for after a designated expiration period.

Process block 540/570 may include the process blocks depicted in FIG. 6. Referring to FIG. 6, a selection of the pre-selected content reference may be received (block 600), and credentials associated with a requesting mobile device may be obtained (block 610). For example, backend server 110 may receive, from mobile device 120, a particular selection of a pre-selected content reference. In one implementation, the particular selection may include a unique identifier for mobile device 120 that allows mobile device 120 to be associated with a particular user account. Backend server 110 may use the unique identifier to determine credentials for mobile device 120. The credentials may be based on, for example, user account information, such as account history (e.g., records of previous downloads) or subscription levels (e.g., premium package subscriptions).

It may be determined if the credentials are valid (block 620). For example, backend server 110 may evaluate distribution limitations defined in the DRM envelope for the selected content reference and compare the distribution limitations to information from the subscriber account. For example, backend server 110 may determine whether mobile device 120 associated with the user account has previously downloaded content related to the selected content reference. If the number of downloads available to a single subscriber are limited and that limit has been reached by the subscriber, backend server 110 may determine that the credentials of mobile device 120 are invalid.

If the credentials are determined to be valid (block 620—YES), a license key for the pre-selected content may be provided (block 630). For example, backend server 110 may provide, to mobile device 120, a license key for the particular pre-selected content. Mobile device 120 may, thus, begin to render the previously downloaded content. If the credentials are determined not to be valid (block 620—NO), the transaction may be rejected (block 640). For example, backend server 110 may send a message to the requesting mobile device 120 that access to the pre-selected content is denied.

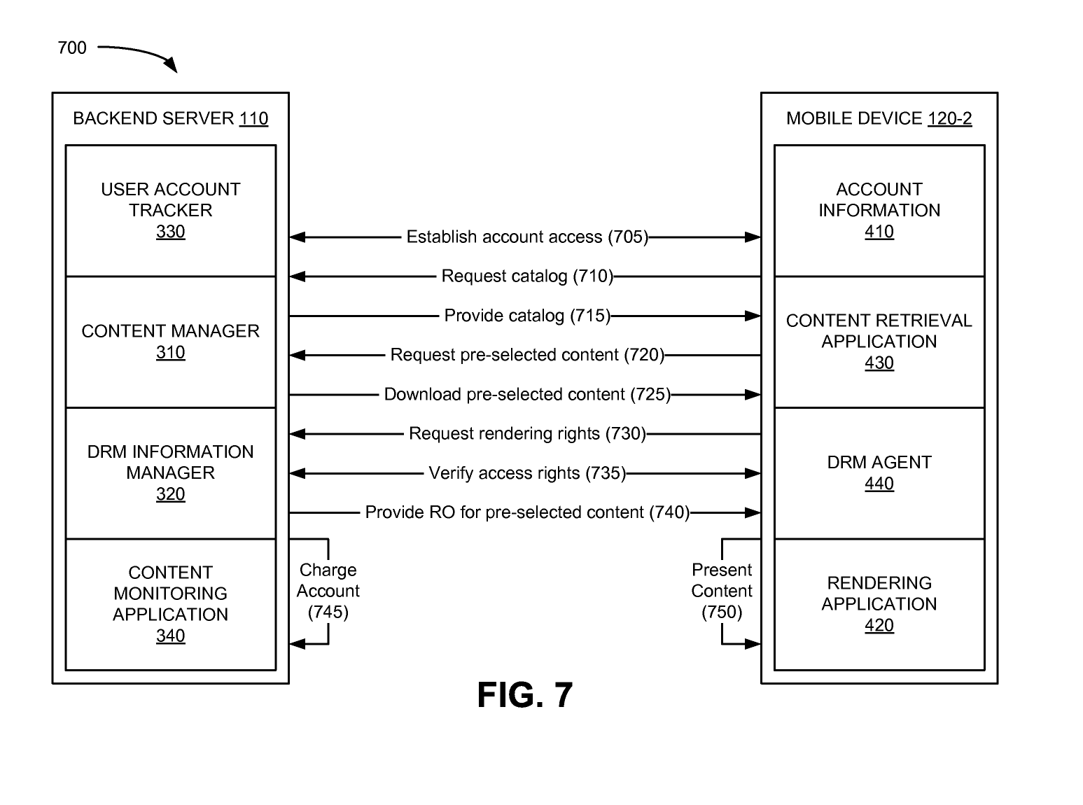

FIG. 7 provides exemplary communications 700 for mobile content distribution operations capable of being performed by the devices of FIGS. 1-4. Assume for the discussion of FIG. 7, mobile device 120-2 is a portable video player with a docking station in a car. More particularly, the car may be used by a family taking an extended trip. A user of mobile device 120-2 (e.g., a parent) may choose to pre-select multiple videos/movies for children to watch while travelling in the car. The user may use mobile device 120-2 to establish 705 an account with backend server 110. While at home using, for example, a high bandwidth WiFi connection of local network 160, the user may log in to the account and request 710 a catalog of available content, and backend server 110 may provide 715 the requested catalog.

Based on user input, mobile device 120-2 may request 720 pre-selected content (e.g., multiple videos/movies) from the catalog options. In response to the request, backend server 110 may download 725 the pre-selected content (e.g., the requested videos/movies) to mobile device 120-2, using the high bandwidth network connection of local network 160. The pre-selected content may include DRM protections that require, for example, separate rights objects to render (view) each video/movie.

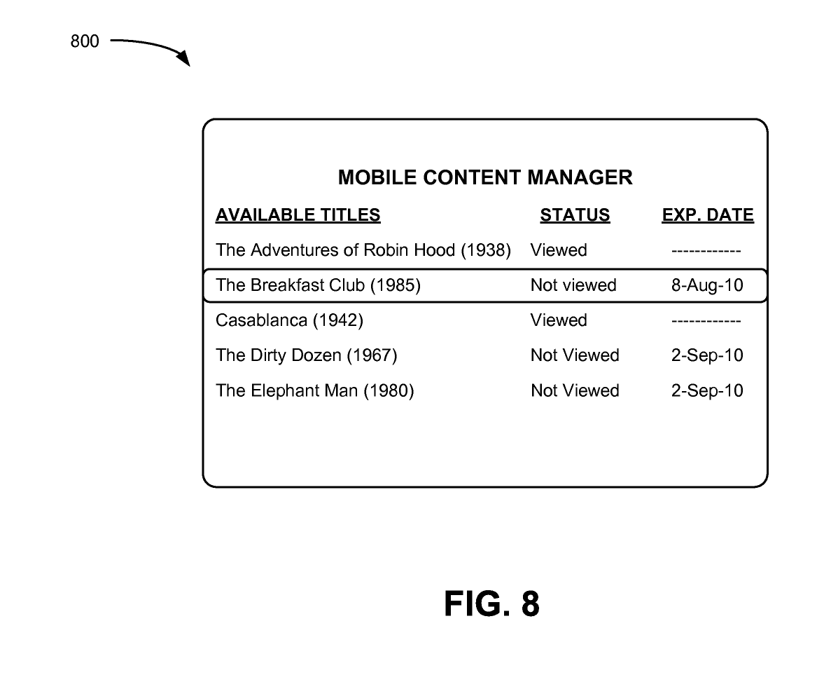

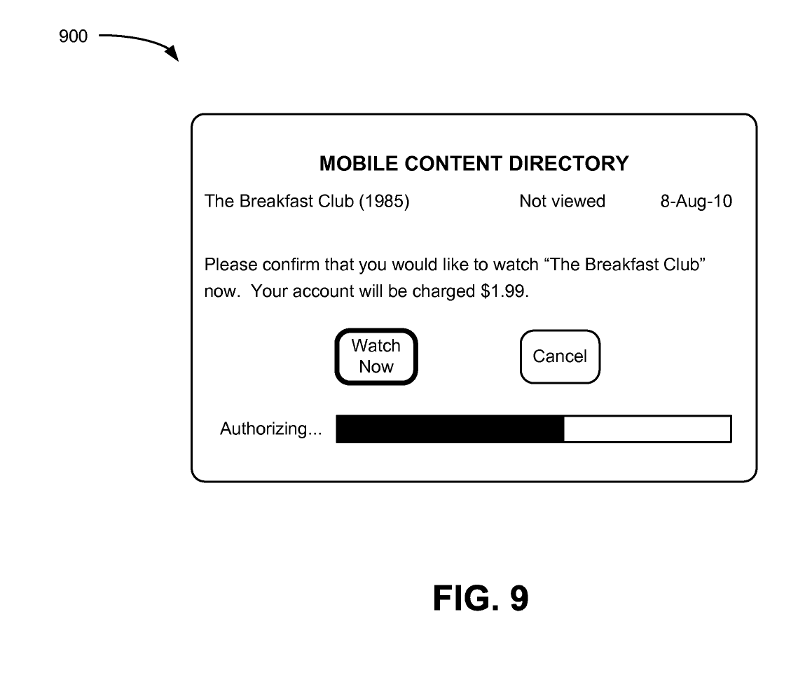

At a later time (e.g., during an extended drive in the car away from home), the user may choose to view one of the videos/movies that was previously downloaded. The user may select from the list of pre-selected titles particular pre-selected content. FIG. 8 provides an example screen 800 that may be displayed on mobile device 120-2 for choosing particular pre-selected content. As shown in FIG. 8, screen 800 may include titles of pre-selected content that were previously downloaded, as well as the status (viewed/not viewed) and expiration date, if applicable. The user may use an input device (e.g., input device 260) to select a particular title (e.g., “The Breakfast Club”). FIG. 9 provides an example confirmation screen 900 for confirming a particular pre-selected content choice. As shown in FIG. 9, confirmation screen 900 may include the selected title and pricing information for the selected title. A user may use the input device to provide confirmation (e.g., “Watch Now”) of the selected title.

Referring back to FIG. 7, upon receiving the user confirmation, mobile device 120-2 may request 730 rights to render the particular pre-selected content. Mobile device 120-2 may communicate with backend server 110 to verify 735 access rights for the particular pre-selected content. For example, backend server 110 may request login information and/or credentials from mobile device 120-2. The verification process between mobile device 120-2 and backend server 110 may by conducted, for example, using a relatively low bandwidth connection (e.g., a 3G or CDMA wireless connection) via access network 150. Assuming the access rights for mobile device 120-2 are verified, backend server 110 may provide 740 DRM security information (e.g., a rights object) for the particular pre-selected content. Backend server 110 may charge 745 the user account, and mobile device 120-2 may present 750 the particular pre-selected content using the downloaded video file and the DRM rights object. Thus, the user of mobile device 120-2 may be charged only for content actually rendered (viewed), while having the option to choose from multiple titles.

The illustration of FIG. 7 provides exemplary communications for providing mobile content distribution. Other arrangements may be used. Also, additional and/or alternative arrangements and techniques may be used to implement DRM controls. For example, in other implementations, DRM security information may be provided before mobile device 120 “goes mobile” to allow access to preselected content when/where no connection to backend server 110 is available.

Systems and/or methods described herein may distribute, to a mobile device, a catalog of available digital content and may receive, from the mobile device, a request to download multiple digital content files based on the catalog. The system and/or methods may send, to the mobile device, the multiple digital content files, where the each of the multiple digital content files includes access restrictions to prevent unauthorized rendering. The system and/or methods may receive, from the mobile device, a request to render one of the multiple digital content files on the mobile device and may determine whether rendering of the one of the multiple digital content files on the mobile device is authorized. The system and/or methods may send, to the mobile device, information to enable rendering of the one of the multiple digital content files if the mobile device is authorized and may apply, to a user account associated with the mobile device, charges based on the sending the information to enable the rendering.

The foregoing description provides illustration and description, but is not intended to be exhaustive or to limit the implementations to the precise form disclosed. Modifications and variations are possible in light of the above teachings or may be acquired from practice of systems and/or methods disclosed herein.

Also, while series of blocks have been described with regard to the flowcharts of FIG. 6 and 7, the order of the blocks may differ in other implementations. Further, non-dependent blocks may be performed in parallel.

It will be apparent that implementations, as described herein, may be implemented in many different forms of software, firmware, and hardware in the implementations illustrated in the figures. The actual software code or specialized control hardware used to implement embodiments described herein is not limiting of the invention. Thus, the operation and behavior of the embodiments were described without reference to the specific software code—it being understood that software and control hardware may be designed to implement the embodiments based on the description herein.

Even though particular combinations of features are recited in the claims and/or disclosed in the specification, these combinations are not intended to limit the disclosure of the invention. In fact, many of these features may be combined in ways not specifically recited in the claims and/or disclosed in the specification.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

What is claimed is:

1. A method performed by a server, comprising:
receiving, by the server and from a mobile device, a request to download pre-selected content;
sending, by the server and to the mobile device, the pre-selected content, where the pre-selected content includes access restrictions to prevent unauthorized rendering;
receiving, by the server and from the mobile device, a request to render the pre-selected content on the mobile device;
obtaining, by the server and from the mobile device, credentials of the mobile device;
determining, by the server and from the mobile device, whether the credentials are acceptable for rendering the content;
sending, by the server and to the mobile device, information to enable rendering of the pre-selected content if the credentials are acceptable for rendering the content; and
applying, by the server, charges to a user account associated with the mobile device based on the rendering of the pre-selected content.

2. The method of claim 1, further comprising:
providing, by the server and to a mobile device, a listing of content options.

3. The method of claim 1, further comprising:
encrypting, by the server, the pre-selected content prior to sending the pre-selected content to the mobile device; and
decrypting, by the mobile device, the pre-selected content.

4. The method of claim 1, where the sending the pre-selected content is conducted using a high bandwidth network connection to the mobile device, and where the sending the information to enable rendering of the pre-selected content is conducted using a lower bandwidth network connection to the mobile device.

5. The method of claim 1, further comprising:
establishing, by the server, the user account associated with the mobile device.

6. The method of claim 1, where the pre-selected content includes an expiration date and instructions for the mobile device to delete the pre-selected content at the expiration date.

7. The method of claim 1, further comprising:
applying charges, by the server, to the user account associated with the mobile device based on a failure to account for the pre-selected content within a particular time period.

8. The method of claim 1, where the information to enable rendering of the pre-selected content includes a rights object.

9. The method of claim 1, where the information to enable rendering of the pre-selected content includes a license key.

10. One or more devices, comprising:
a memory to store instructions; and
a processor to execute the instructions to:
distribute, to a mobile device, a catalog of available digital content,
receive, from the mobile device, a request to download multiple digital content files based on the catalog,
send, to the mobile device, the multiple digital content files, where each of the multiple digital content files includes access restrictions to prevent unauthorized rendering by the mobile device,
receive, from the mobile device, a request to render one of the multiple digital content files on the mobile device,
determine whether rendering of the one of the multiple digital content files on the mobile device is authorized,
send, to the mobile device, information to enable rendering of the one of the multiple digital content files if the mobile device is authorized, and
apply, to a user account associated with the mobile device, charges based on the sending the information to enable rendering of the one of the multiple digital content files.

11. The one or more devices of claim 10, where the processor further executes instructions to:
receive the digital content from a source media client, and
send the digital content to the requesting media client over a closed content delivery channel.

12. The one or more devices of claim 10, where the memory further stores the user account information associated with the mobile device, and where the processor further executes instructions to update the user account information based on the sending the multiple digital content files.

13. The one or more devices of claim 10, where the processor further is to execute the instructions to:
apply charges to the user account information based on a failure to account for another one of the multiple digital content files within a particular time period.

14. The one or more devices of claim 10, where the credentials of the mobile device include:
a unique identifier for the mobile device.

15. The one or more devices of claim 10, where the information to enable rendering of the multiple digital content files includes one of a rights object or a license key.

16. A method performed by a server, comprising:
receiving, by the server and from the mobile device, a request to download multiple digital content files;
obtaining, by the server and from the mobile device, credentials of the mobile device;
determining, by the server and from the mobile device, whether the credentials are acceptable for allowing rendering of the multiple digital content files;
sending, by the server and to the mobile device, the multiple digital content files, where each of the multiple digital content files includes access restrictions to prevent unauthorized rendering;
sending, by the server and to the mobile device, information to enable rendering of each of the multiple digital content files if the credentials are acceptable for allowing rendering the content;
receiving, by the server and from the mobile device, a notification that one of the multiple digital content files has been rendered on the mobile device; and
applying, by the server, charges to a user account associated with the mobile device based on the notification.

17. The method of claim 16, where the notification that one of the multiple digital content files has been rendered on the mobile device is included as part of a synchronization session between the server and the mobile device.

18. The method of claim 17, further comprising:
applying charges, by the server, to the user account associated with the mobile device if one of the multiple digital content files is unaccounted for within a particular time period.

19. One or more devices, comprising:
a memory to store instructions; and
a processor to execute the instructions to:
receive, from the mobile device, a request to download multiple digital content files,
send, to the mobile device, the multiple digital content files, where the each of the multiple digital content files includes access restrictions to prevent unauthorized rendering by the mobile device,
determine, whether rendering of each of the multiple digital content files on the mobile device is authorized,
send, to the mobile device, information to enable rendering of the one of the multiple digital content files if rendering of each of the multiple digital content files on the mobile device is authorized, and
receive, from the mobile device, a notification that one of the multiple digital content files has been rendered on the mobile device, and
apply, to a user account associated with the mobile device, charges based on the sending the information to enable rendering of the one of the multiple digital content files.

20. The one or more devices of claim 19, where the processor further is to execute the instructions to:
store, in the memory, a record of each of the multiple digital content files sent to the mobile device, and
apply, to the user account, a fee when one of the multiple digital content files is unaccounted for within a particular time period.
